(19) United States
(12) Patent Application Publication
(10) Pub. No.: US 2005/0206074 A1
(43) Pub. Date: Sep. 22, 2005

(54) Sheet conveyer and image recording apparatus

(75) Inventor: Yoshiyuki Tsuzawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/076,915

(22) Filed: Mar. 11, 2005

(30) Foreign Application Priority Data
Mar. 19, 2004 (JP) 2004-081285

(51) Int. Cl. B65H 5/34; G03G 15/24

(52) U.S. Cl. 271/270

(57) ABSTRACT

When a sensor detects a leading end of a recording sheet, a movable distributing mechanism distributes the recording sheet to a first distributing position. When a sensor 50a detects the leading end of the recording sheet, the mechanism switches conveyer rollers and to the releasing position and returns them to the center position. Next, responding to that a sensor detects a trailing end of the recording sheet, the conveyer rollers and are reset to the nipping position and accept a second recording sheet. When the sensor detects a leading end of the recording sheet, the movable distributing mechanism distributes the second recording sheet to a second distributing position, opposite to the first distributing position. Rearward recording sheets are distributed alternately to the first and second positions.

### FIELD OF THE INVENTION

The present invention relates to a conveyer that conveys sheets supplied in single line in a transport direction, moves the sheets in a distributing direction that is almost orthogonal to the transport direction, and then feeds out the sheet in plural lines. The present invention relates also to an image recording apparatus using the conveyer.

### BACKGROUND ART

One of widely available image recording apparatuses is a printer processor that makes a photo print by exposing image on photosensitive recording paper with recording light whose intensity is modulated based on digital image data gained by photoelectrically reading image recorded in a photo film or image data recorded in such a recording medium as a memory card, and by developing and drying it.

Among such printer processors, one with a paper distributing device that distributes cut sheets of exposed recording paper to plural lines by shifting a pair of conveyer rollers in a width direction of the sheet and then conveys them to a processor section is disclosed for example in Japanese Laid-open Patent Application No. Hei 09-329885.

In the above prior art, the cut sheets of recording paper are distributed by moving a pair of cylindrical rollers to their axial direction. But because the width of the pair of rollers is the same as one of the recording sheet, the pair of rollers returns to the initial position after the recording sheet passed the pair of rollers, to accept the next recording sheet.

In these years, high-speed processing as well as improvement of image quality are significant challenges for the printer processor. As for the distributing device in the above prior art, however, the return time prevents speeding up. To solve the problem, there is a method to make the width of the pair of distributing rollers longer than one of the recording sheet so as to omit the return motion. But this method involves so-called offset conveyance that the pair of distributing rollers does not nip the recording sheet symmetrically to its center. The offset conveyance will result variations in abrasion degree of the pair of distributing rollers along the axial direction, so the suppress strengths to the recording sheet become different along the axial direction, which causes occurrence of skew, conveying the recording sheet askew.

In order to solve the above problem, it is proposed to line more than three narrow rollers, hereinafter referred to as the roller balls, on a longer bearing shaft than the width of the recording sheet in the axial direction of the shaft, and to make the stuck roller balls nip the recording sheet symmetrically to the center of the recording sheet.

However, in those cases where the recording sheets are conveyed repeatedly in single line or plural lines at random according to the widths of the recording sheets, a difference in passing frequency of the recording sheets through individual roller balls makes a difference in abrasion degree and then in nipping pressure to the recording paper between the roller balls, thereby causing occurrence of skew. In addition, in order to cope with plural kinds of sizes of recording sheets, it is necessary to change intricately control method of conveyance according to the lengths of the recording sheets in the transport direction.

### SUMMARY OF THE INVENTION

In view of the foregoing, an object of the present invention is to provide a conveyer that distributes sheets at a high speed and with accuracy while lessening difference in abrasion degree between rollers that results from aging, and an image recording apparatus using the conveyer.

According to the present invention, a conveyer for conveying sheets sequentially in a transport direction comprises:
a distributing device movable in a distributing direction that is substantially orthogonal to the transport direction, while nipping and conveying the sheets one by one in the transport direction;
   a shift device that drives the distributing device to move in the distributing direction;
a switching device for switching over the distributing device between a nipping position to nip the sheet and a releasing position to release the sheet;
   a conveying device disposed behind the distributing device with respect to the transport direction, to nip and convey the sheet;
a first detector disposed between the distributing device and the conveying device, to detect the sheet passing;
   a second detector disposed behind the conveying device with respect to the transport direction, to detect the sheet passing; and
   a conveyance control device for controlling the distributing device through the shift device and the switching device such that the distributing device is switched to the nipping position at a reference position to nip and convey a forward one of the sheets, and is moved in the distributing direction in response to that the first detector detects a leading end of the forward sheet, and that the distributing device is switched to the releasing position and moved back to the reference position, getting ready for nipping and conveying a rearward one of the sheets, in response to that the second detector detects the leading end of the forward sheet.

It is preferable to switch the distributing device from the releasing position to the nipping position in response to that the first detector detects a trailing end of the forward sheet.

According to a preferred embodiment, the distributing device is movable in the distributing direction between a first position and a second position, which are substantially symmetrical about the reference position, and the distributing device moves to the first position to convey the forward sheet toward the conveying device and, thereafter, nips the rearward sheet at the reference position and moves to the second position to convey the rearward sheet toward the conveying device, to distribute the sheets as being conveyed in single line into two lines.

The distributing device preferably nips the sheet at symmetrical positions to a center line of the sheet with respect to the distributing direction.

An image recording apparatus of the present invention comprises:
an image recording section for recording an image on a recording material, the recording material being conveyed in a transport direction;
a photographic processing section for developing the recording material after having the image recorded thereon; and
a conveyer disposed between the image recording section and the photographic processing section, said conveyer being supplied with the recording materials in single line and feeding out the recording materials in plural lines, the conveyer comprising:
a distributing device movable in a distributing direction that is substantially orthogonal to the transport direction, while nipping and conveying the recording materials one by one in the transport direction;
a shift device that drives the distributing device to move in the distributing direction;
   a switching device for switching over the distributing device between a nipping position to nip the recording material and a releasing position to release the recording material; a conveying device disposed behind the distributing device with respect to the transport direction, to nip and convey the recording material;
   a first detector disposed between the distributing device and the conveying device, to detect the recording material passing through the first detector;
   a second detector disposed behind the conveying device with respect to the transport direction, to detect the recording material passing through the second detector; and
   a conveyance control device for controlling the distributing device through the shift device and the switching device, such that the distributing device is switched to the nipping position at a reference position, to nip and convey a forward one of the recording materials, and is moved in the distributing direction in response to that the first detector detects a leading end of the forward recording material, and that the distributing device is switched to the releasing position and moved back to the reference position, getting ready for nipping and conveying a rearward one of the recording materials, in response to that the second detector detects the leading end of the forward recording material.

The conveyer is preferably assembled as a convertible unit.

According to the present invention, the distributing device is switched to the nipping position at a reference position, to nip and convey the forward sheet, and is moved in the distributing direction in response to that the first detector detects the leading end of the forward sheet. Thereafter when the second detector detects the leading end of the forward sheet, the distributing device is switched to the releasing position and moved back to the reference position, getting ready for nipping and conveying the rearward sheet.

Accordingly, the distributing device nips the sheet evenly throughout the length of the distributing device in the distributing direction, regardless of the length of the sheet in the distributing direction. Therefore, the degree of abrasion or frictional wearing on nipping portions of the distributing device will be substantially uniform. Since the distributing device is switched to the releasing position as it is moved back to the reference position, it is possible to feed the rearward sheet into the distributing device during the returning movement to the reference position. Thus the sheets can be processed at a high speed. Furthermore, because the distributing device is controlled in response to the detection results of the first and second detectors, distribution is achieved accurately even if the sheets to convey have various sizes.

Configuring the distributing device to nip the sheet at symmetrical positions to a center line of the sheet with respect to the distributing direction prevents the sheets from skewing.

Assembling the conveyer as a convertible unit permits improving the processing capacity of the image recording apparatus just by replacing the convertible unit, which contributes to saving the improvement cost.

### BRIEF DESCRIPTION OF THE DRAWINGS

FIG. 1 is an explanatory diagram schematically illustrating the interior of an image recording apparatus;

FIG. 2 is a schematic perspective view illustrating the interior of a sheet distributing section;

FIG. 3 is a schematic perspective view illustrating a mechanism to rotate two pairs of conveyer rollers at the sheet distributing section;

FIG. 4 is a schematic sectional view illustrating the interior of a pipe slide;

FIG. 5 is a schematic perspective view illustrating the interior of nip rollers;

FIG. 6 is a schematic perspective view illustrating the interior of a release mechanism for releasing the nip rollers;

FIGS. 7, 8, 9 and 10 are explanatory diagrams illustrating the process of distributing recording sheets at the sheet distributing section;

FIG. 11 is a schematic perspective view illustrating the interior of a release mechanism using a long cam;

FIG. 12 is a schematic perspective view illustrating the interior of another release mechanism using a long gear;

FIG. 13 is a schematic perspective view illustrating the interior of still another release mechanism using a pipe slide; and

FIG. 14 is a schematic perspective view illustrating essential parts of a further embodiment using a chucker mechanism instead of the conveyer rollers.

### DESCRIPTION OF THE PREFERRED EMBODIMENTS

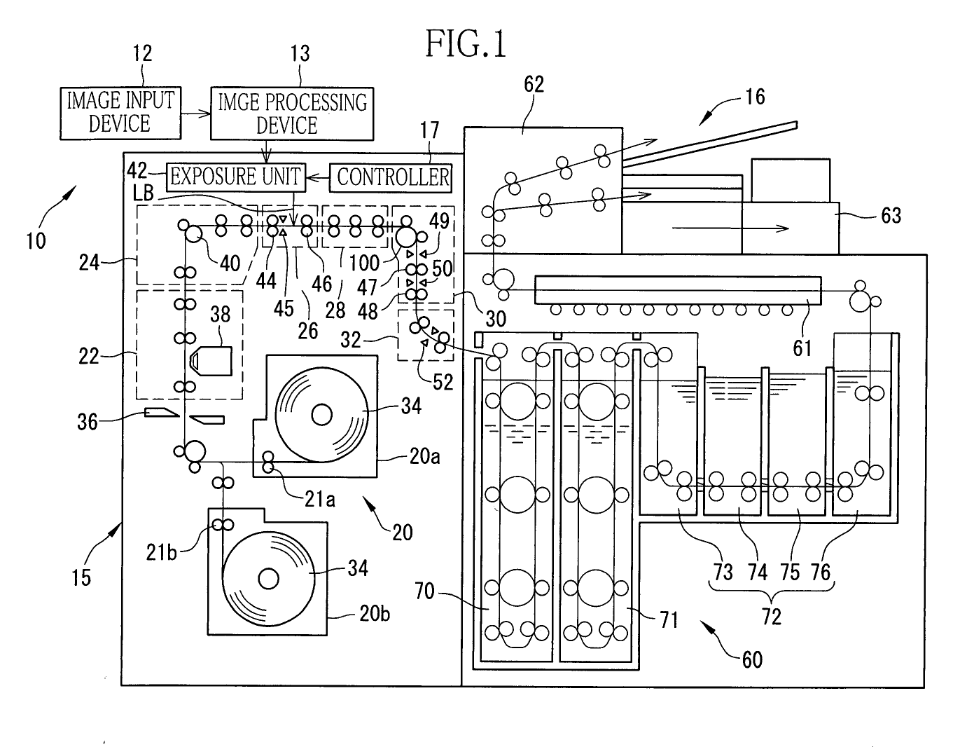

FIG. 1 schematically illustrates the interior of a printer processor as an image recording apparatus according to an embodiment of the present invention. The printer processor 10 is provided with an image input device 12, an image processing device 13, a printer 15 and a processor 16. Every part of the printer processor 10 is connected with a controller 17 by wiring unshown in the drawings, and the controller 17 controls the whole operations of the printer processor 10.

The image input device 12 generates image data by reading photoelectrically an optical image of a picture recorded on photo film, using an image pickup device like a CCD image sensor, or gains image data by reading image data recorded in such a recording medium as a memory card. The image data is sent to the image processing device 13 which carries out some image processes including a color balance correction and a density adjustment. The processed image data is sent to the printer 15 and used in after-mentioned image recording.

The printer 15 carries out image recording by use of light whose intensity is modulated based on image data while conveying a given length of cut-sheet recording paper. The printer 15 is provided with a paper supply section 20, a back-printing section 22, a registering section 24, an image recording section 26, a sub scan supporting section 28, a sheet distributing section 30 which uses a conveyer of the present invention, and a feed out section 32, in the order from the upstream of a transport direction. Through all sections a plural number of pairs of conveyer rollers which consist of driving rollers and nip rollers are disposed along a cut-sheet paper path.

The paper supply section 20 is set with magazines 20a and 20b which contain a roll of long web of photosensitive recording paper 34 each. Both magazines 20a and 20b are provided with a pair of drawing rollers to pull and send the photosensitive recording paper 34 to the back-printing section 22. According to this embodiment, two magazines 20a and 20b are installed. However the number of the magazine can be one or more than three.

At a given distance from outlets of the magazines 20a and 20b, a cutter 36 is installed to cut the photosensitive recording paper 34. Driven by a control signal from the controller 17, the cutter 36 cuts the photosensitive recording paper 34 as sent forth to a given length according to a designed print size into a cut-sheet of recording paper or called a recording sheet. For example, the recording paper of a given width is cut into a given length according to such sizes of photo prints as L size (89 mm ˜127 mm), panorama size (89 mm ˜254 mm), 2L size (127 mm ˜178 mm), one-eighth size (165 mm ˜216 mm), one-sixth size (203 mm ˜254 mm), and quarter size (254 mm ˜305 mm) Moreover according to this embodiment a double-blade cutter is used, but instead of it, it is possible to use any known device including a rotary cutter using a rotary blade.

The back-printing section 22 has a back-printing head 38 which records some print information including a date of photographing, a date of printing, a frame serial number and various kinds of ID on the opposite side to a photosensitive surface of the recording sheet. As for the back-printing head 38, it is possible to use such known print heads as a dot impact head, an ink jet head and a thermal transfer print head as long as they are resistant to a wet processing procedure to be done later.

The registering section 24 consists of a pair of registering rollers 40 which adjusts the tilt and position to a width direction of the recording sheet so that its exposure position and angle are not out of place at the image recording section 26, and plural pairs of conveyer rollers placed back and forth the pair of roller for registering 40. As for a way to adjust the tilt and position in the width direction by the pair of registering rollers 40, it is possible to choose among known ways like a tilt registering, a top registering and a side registering.

The image recording section 26 consists of an exposure unit 42, pairs of sub scan rollers 44 and 46 and a paper sensor 45 which detects a passage of the recording sheet, and all operations of this section are controlled by the controller 17. The exposure unit 42 is connected to the image processing device 13. After the paper sensor 45 detects a passage of a leading end of the recording sheet, the exposure unit 42 scans red, green and blue light beams LB whose intensities are modulated based on image data, in a main scan direction (i.e. the direction orthogonal to the transport direction) to record image on the recording sheet.

Placed before and behind an exposure position to the light beams LB in the transport direction, the pairs of sub scan rollers 44 and 46 convey the recording sheet at a given speed in a sub scan direction (i.e. in parallel to the transport direction). Moreover, it is possible for nip rollers of the pairs of sub scan rollers 44 and 46 to switch their positions between nipping the recording sheet and being away from it. And the nip rollers switch their positions when a position sensor unshown in the drawings detects a leading end or trailing end of the recording sheet. This system prevents excessive impact on the recording sheet, which would otherwise be given as the leading end of the recording sheet hits the downstream pair of sub scan rollers 46 or as the trailing end of it gets out of the upstream pair of sub scan rollers 44.

The sub scan supporting section 28 has plural pairs of rollers which hold the leading end of the recording sheet sent from the image recording section 26 during image recording, and sends the recording sheet downstream at the same speed as transport speed by the image recording section 26. Every pair of rollers at the sub scan supporting section 28 consists of the driving roller and the nip roller possible to release, and nips the recording sheet after the passage of the leading end of it during image recording. This system prevents the fluctuation of the transport speed because of a bump of the leading end of the recording sheet.

The sheet distributing section 30 consists of a movable distributing mechanism 100 which distributes the recording sheets, as being conveyed in single line, to plural lines (two lines according to this embodiment) in the main scan direction while conveying the recording sheet at a predetermined first speed, pairs of conveyer rollers 47 and 48 sending the distributed recording sheets to the feed out section 32, and sensors 49 and 50 to detect the passage of the recording sheet. The sheet distributing section 30 is made as a convertible unit that can be attached to or removed from the printer processor 10, so that the one whose capacity is suitable for the processing speed of the printer processor 10 is used.

And the feed out section 32 conveys the recording sheet from the sheet distributing section 30 to the processor 16 at a second speed corresponding to the processing speed of the processor 16. The sensors 49 and 50 at the sheet distributing section 30 and the sensor 52 at the feed out section 32 are optical sensors consisting of for example a light-emitting diode and a photodiode, whose output level changes during the passage of the recording sheet. This system enables the sensors to detect the passage of the leading or trailing end of the recording sheet.

The processor 16 consists of a developing section 60, a dry section 61, a gathering section 62 and a sorter section 63. The developing section 60 is provided with a developing tank 70, a bleach fix tank 71 and wash tanks 72 consisting of the first wash tank 73, the second wash tank 74, the third wash tank 75 and the fourth wash tank 76, in this order from the upstream of the transport direction. The developing tank 70, the bleach fix tank 71 and the first to fourth wash tanks 73, 74, 75 and 76 store a given amount of developing solution, bleach-fix bath and wash water respectively. The recording sheet is developed, fixed and washed by being conveyed through every processing tank 70, 71 and 72 by driving force of conveyer racks placed respectively in the developing tank 70, the bleach fix tank 71 and the first to fourth wash tanks 73 to 76.

The dry section 61 is arranged above every processing tank 70 to 72 and consists of a conveyer belt and a fan duct. The fan duct blows dry air heated by a heater to the conveyer belt and presses the recording sheet on the conveyer belt. Passing above the fan duct in this state removes water from the recording sheet.

After passing the dry section 61, the recording sheet is then sent to the gathering section 62. The gathering section 62 gathers the recording sheets conveyed in two lines into single line. The sorter section 63 sorts the plural sheets sent from the gathering section 62 into respective print jobs, and sends them out in the sorted groups.

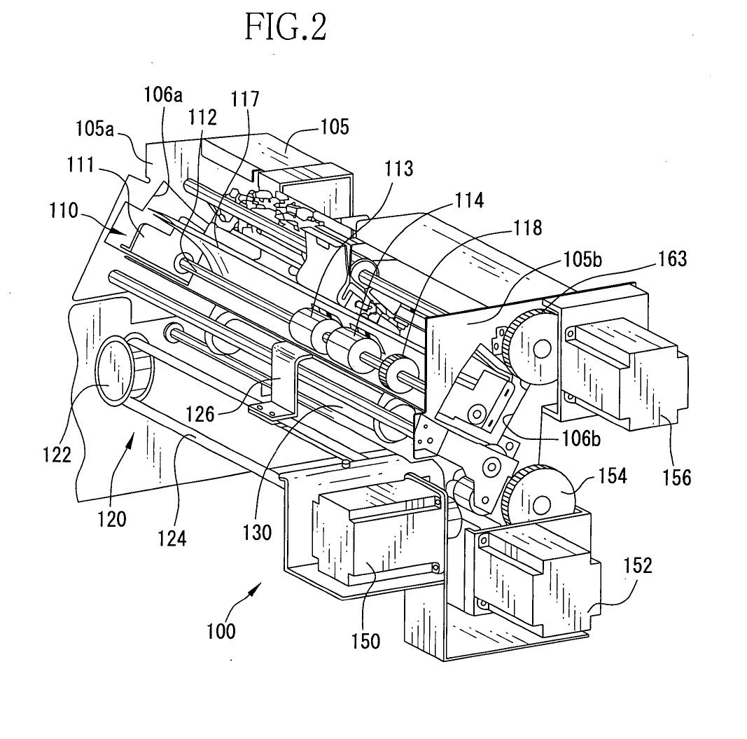

As FIG. 2 shows, the movable distributing mechanism 100 for distributing the recording sheets into two lines comprises a movable body 110 as a distributing device of the present invention, and a driving section 120 as a shift device of the present invention, which drives the movable body to move in the main scan direction. The movable body 110 and the driving section 120 are located inside a frame 105. When the movable body 110 moves in the main scan direction, a part of it projects out of either of windows 106a and 106b which are formed on opposite sides 105a and 105b of the frame 105.

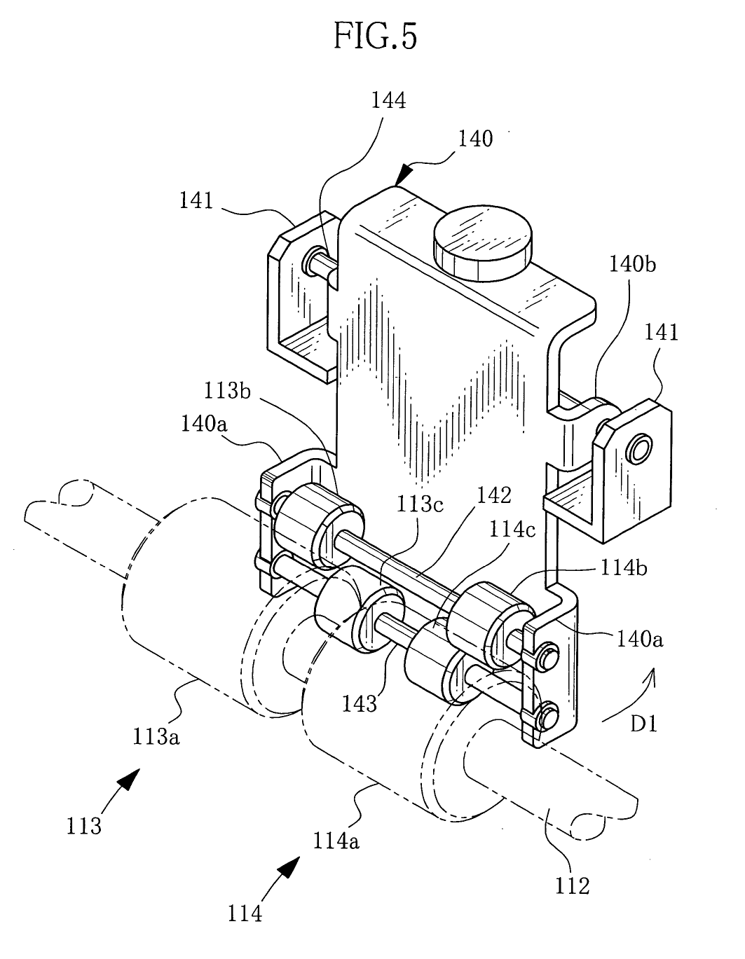

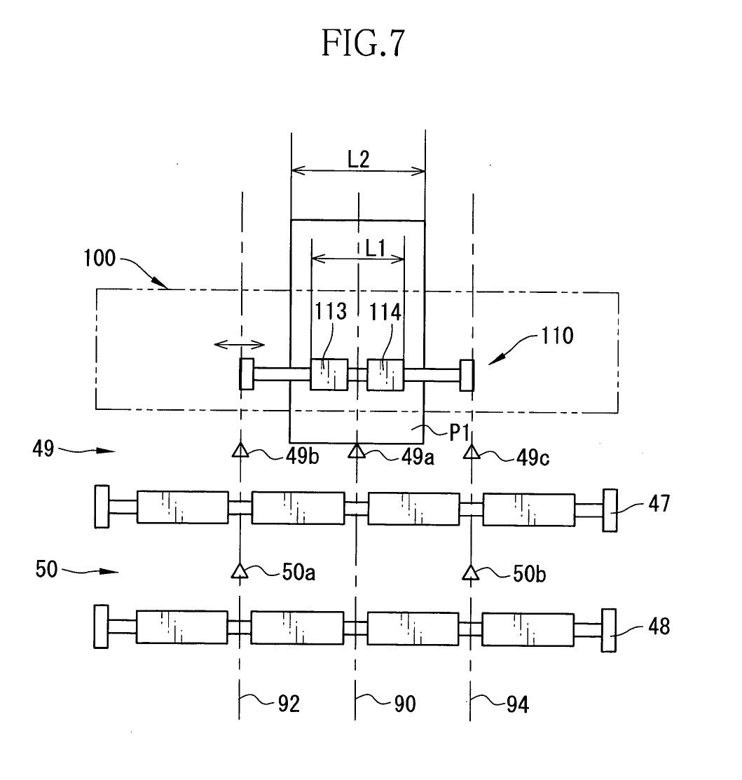

The movable body 110 has a long-shape housing 111 located in alignment with the windows 106a and 106b, a bearing shaft 112 which is mounted on the housing 111 and extends in the main scan direction, and two pairs of conveyer rollers 113 and 114 that nip the recording sheet. As will be mentioned later, the pairs of conveyer rollers 113 and 114 consist of driving rollers 113a and 114a fixed on the bearing shaft 112 and nip rollers 113b, 114b, 113c and 114c nipping the recording sheet with the driving rollers 113a and 114a, as shown in FIG. 5. Furthermore, as shown in FIG. 7, a length L1 from an axial end to an opposite axial end of the driving roller pairs 113 and 114 is shorter than a minimum width L2 of the recording sheets to convey.

The housing 111 is provided with a pair of guide plates 117 having a gap between them so that the recording sheet passes through the gap. And the movable body 110 has a seamless pipe slide 130, hereinafter referred to as the pipe slide, that enables the rotating pairs of conveyer rollers 113 and 114 to move in the main scan direction.

The driving section 120 has a pair of pulleys 122 and an endless belt 124 wound around the pulleys 122. One of the pulleys 122 unshown in the FIG. 2 is connected to a movable distributing motor 150. And the driving section 120 is provided with a joint member 126 connecting the endless belt 124 to the housing 111. By rotating the movable distributing motor 150 forward or backward, the movable body 110 moves in the main scan direction by the intermediary of the endless belt 124 and the joint member 126.

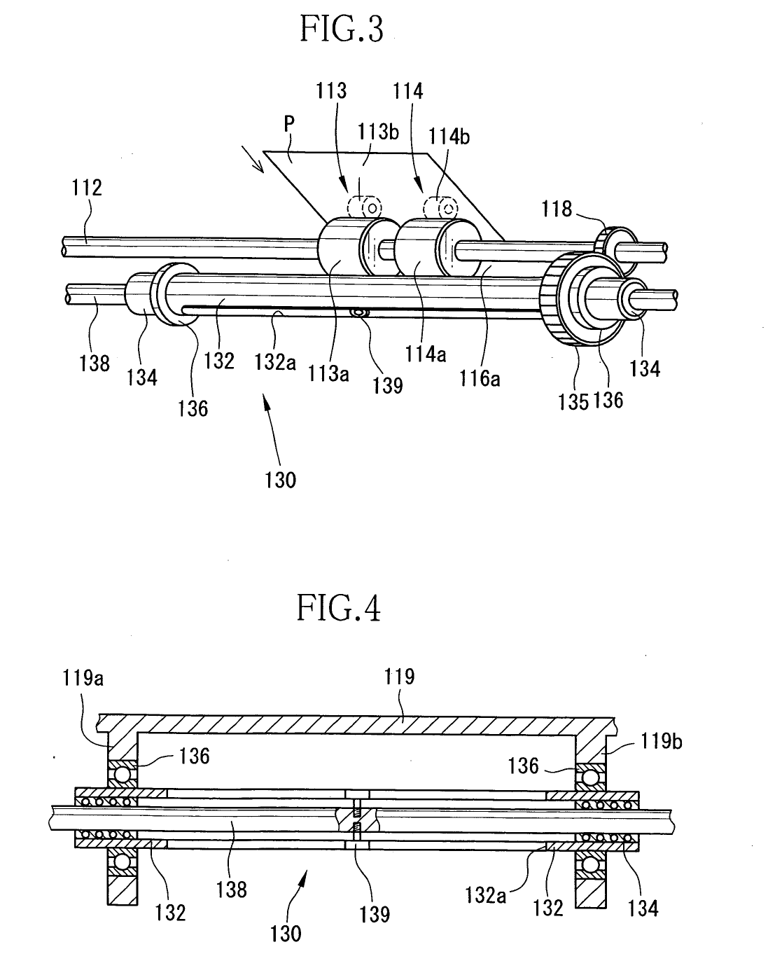

The pipe slide 130 is installed to transmit the driving force to rotate the pairs of conveyer rollers 113 and 114 and, as FIGS. 3 and 4 show, consists of a sleeve 132, a slide bearing 134 and a rotary shaft 138. The cylindrical sleeve 132 is pivotally held via ball bearings 136 on flanges 119a and 119b made on the underside 119 of the housing 111. The sleeve 132 is also movable in an axial direction of the rotary shaft 138 i.e. in the main scan direction by the slide bearing 134 provided on'the inner periphery of both ends of the sleeve 132, and is pivotally held on the rotary shaft 138.

The rotary shaft 138 is pivotally held in the frame 105 and one end of it is connected to a conveyer motor 152 via a gear 154. On the rotary shaft 138, a rotation transmitting member 139 consisting of a bearing section and a shaft section is screwed. The bearing section of the rotation transmitting member 139 transmits the rotation of the rotary shaft 138 to the sleeve 132 in engagement with a pair of grooves 132a in the sleeve 132. As the movable body 110 moves in the main scan direction, the rotation transmitting member 139 also moves along the groove 132a in the sleeve 132 and finally touches the end of the groove 132a, thereby limiting the moving range of the movable body 110 in the main scan direction.

The bearing shaft 112 to support the driving rollers 113a and 114a is provided with a gear 118 which engages with a gear 135 around the sleeve 132. When the conveyer motor 152 rotates by the driving signal from the controller 17, the rotary shaft 138 rotates first and then the sleeve 132 rotates via the rotation transmitting member 139. Moreover the bearing shaft 112 rotates via the gears 118 and 135, and then the driving rollers 113a and 114a fixed on the bearing shaft 112 rotate. With such series of rotation, the pairs of conveyer rollers 113 and 114 nip and convey the recording sheet P sent into the movable distributing mechanism 100.

The nip rollers 113b, 114b, 113c and 114c are pivotally held in a holding frame 140, as shown in FIG. 5, and are fixed to the housing 111 by a fixing member 141.

Both sides of one end of the holding frame 140 are bent almost perpendicularly to form a pair of shaft supporting sections 140a. At the shaft supporting section 140a, a rotary shaft 142 bearing one pair of nip rollers 113b and 114b and another rotary shaft 143 bearing the other pair of nip rollers 113c and 114c are apposed in a lengthwise direction of the holding frame 140. On the other hand, both sides of the other end of the holding frame 140 bending to opposite direction to the shaft supporting section 140a become a pair of joint sections 140b. Through the joint section 140b is inserted a bearing shaft 144 which is pivotally held in the fixing member 141. Such structure allows the nip rollers 113b, 114b, 113c and 114c to switch their positions by an after-mentioned release mechanism 160 between a nip position where the nip rollers nip the recording sheet with the driving rollers 113a and 114a and a release position where they release the recording sheet by rotating in an arrowed direction D1.

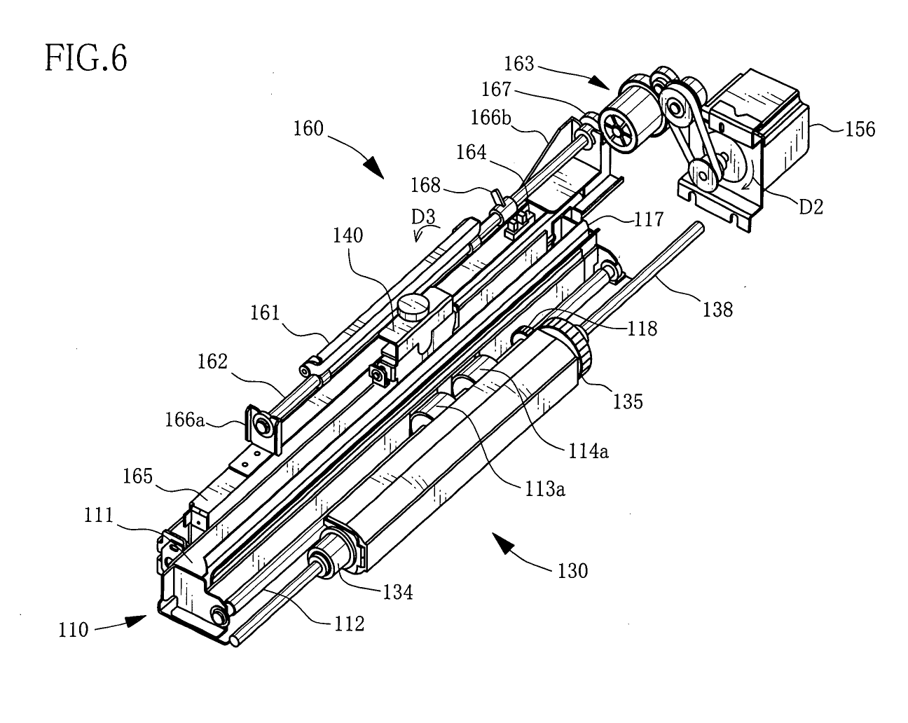

FIG. 6 is a schematic perspective view illustrating the interior of the release mechanism 160. The release mechanism 160 consists of a press member 161 to press the holding frame 140 and switch the positions of the nip rollers 113b, 114b, 113c and 114c between nipping one and releasing one, a bearing shaft 162 to bear the press member 161, a releasing motor 156 to rotate the bearing shaft 162 via a transmission mechanism 163, a photo-interrupter 164 to detect the rotational position of the bearing shaft 162 and a housing 165 to hold the bearing shaft 162, the photo-interrupter 164 and others.

The bearing shaft 162 to bear the press member 161 is pivotally held in the housing 165 via fixing members 166a and 166b, and is connected to the transmission mechanism 163 by a gear 167 provided on one end of the shaft. The bearing shaft 162 is also provided with a block piece 168 to set in a gap in the photo-interrupter 164 and block detection light.

The transmission mechanism 163 consists of a pair of pulleys connecting to the releasing motor 156, an endless belt wound around the pulleys, various kinds of gears, and transmits the rotation of the releasing motor 156 to the bearing shaft 162.

The photo-interrupter 164 is an optical sensor which changes its output responding to that the block piece 168 blocks the detection light, and detects the rotational position of the bearing shaft 162 by the controller's detection of the change.

Instead of the photo-interrupter 164, it is possible to use another sensor like for example a contact limit sensor insofar as the sensor can detect the rotational position of the bearing shaft 162. And it is also possible to control the rotational position of the bearing shaft 162 according to the driving time of the releasing motor 156.

The housing 165 holding the photo-interrupter 164 and the bearing shaft 162 is fixed to the frame 105 of the movable distributing mechanism 100.

The releasing motor 156 rotates forward (in an arrowed direction D2) or backward responding to the driving signal from the controller 17. By sending the driving signal from the controller 17 and rotating the releasing motor 156 forward when the nip rollers 113b, 114b, 113c and 114c are in the nipping position, the bearing shaft 162 rotates in an arrowed direction D3 via the transmission mechanism 163. With the rotation of the bearing shaft 162, the press member 161 fixed on the shaft rotates, presses the holding frame 140 and releases the nip rollers 113b, 114b, 113c and 114c. In this case, responding to that the photo-interrupter 164 detects the block piece 168, the controller 17 stops sending the driving signal to the releasing motor 156 to prevent the bearing shaft 162 from rotating needlessly.

On the other hand, when the nip rollers 113b, 114b, 113c and 114c are in the releasing position, rotating the releasing motor 156 backward releases the press on the holding frame 140 by the press member 161 and returns the nip rollers 113b, 114b, 113c and 114c to the nipping position again.

Now the operation of the printer processor 10 in the above described embodiment will be explained.

Receiving a print order, the controller 17 draws the photosensitive recording paper 34 to a given length from the magazines 20a and 20b loaded in the paper supply section 20 and cuts it into the recording sheet by driving the cutter 36. After being recorded with given information including photographic information at the back-printing section 22, the recording sheet is adjusted the skew or position of the main scan direction at the registering section 24. The recording sheet going past the registering section 24 is conveyed to the image recording section 26 where the recording sheet is exposed to the scanning light beams LB whose intensity is modulated based on image data from the image processing device 13, to have an image recorded thereon.

After the completion of the image recording, the recording sheet passes through the sub san supporting section 28 into the sheet distributing section 30. When the width of the recording sheet is the possible length to be distributed, the sheet distributing section 30 distributes the recording sheet from a center position 90 to either a first distributing position 92 or a second distributing position 94 by driving the movable distributing motor 150 (see FIG. 7). Because the movable body 110 uses the pipe slide 130 with less frictional resistance, it is possible to make distribution at a high speed and carry on conveyance in the main scan direction, i.e. distribution, simultaneously with conveyance in the sub scan direction.

When the width of the recording sheet is the possible length to be distributed, as shown in FIG. 7, the sheet distributing section 30 drives the movable distributing motor 150, responding to that the sensor 49a detects the leading end of the recording sheet P1, to move the movable body 110 of the movable distributing mechanism 100 in the main scan direction and distributes the recording sheet P1 nipped by the pairs of conveyer rollers 113 and 114 to either the first distributing position 92 or the second distributing position 94. Now the case of distribution to the first distributing position 92 will be explained.

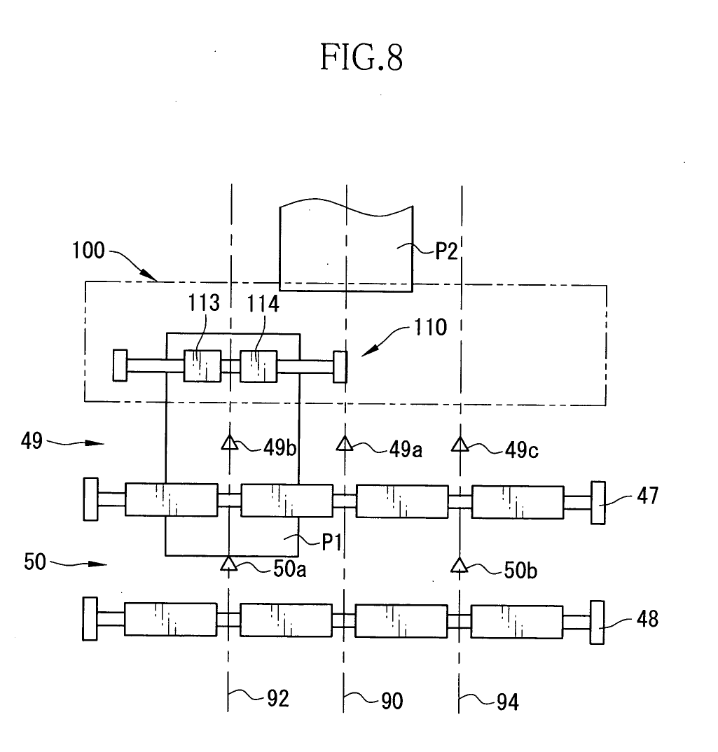

After distributing the recording sheet P1 to the first distributing position 92, the movable distributing mechanism 100 continues to convey the recording sheet P1 in the sub scan direction, as FIG. 8 shows, drives the releasing motor 156 responding to that the sensor 50a detects the leading end of the recording sheet P1, and returns the movable body 110 to the center position 90 after releasing the pairs of conveyer rollers 113 and 114.

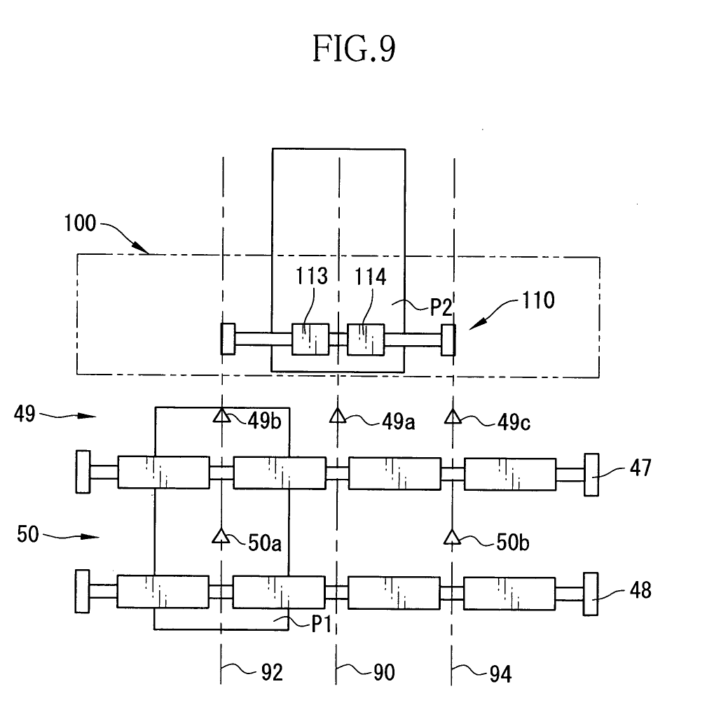

The recording sheet P1 in the first distributing position 92 is conveyed further in the sub scan direction by the pairs of conveyer rollers 47 and 48. As FIG. 9 shows, responding to that the sensor 49b detects the trailing end of the recording sheet P1, the pairs of conveyer rollers 113 and 114 return to the nipping position and are ready for accepting the next recording sheet P2.

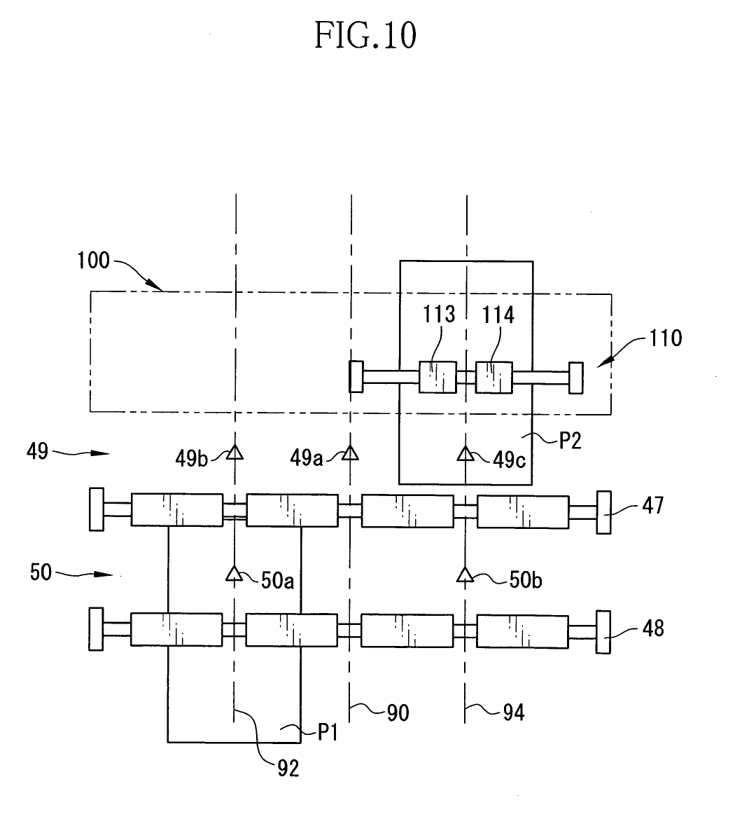

Next responding to that the sensor 49a detects the leading end of the recording sheet P2, the recording sheet P2 is distributed to the second distributing position 94, opposite position to the recording sheet P1, as shown in FIG. 10. Hereafter, when the width of the recording sheet is a possible length to distribute, the recording sheets are distributed alternately to the first distributing position 92 and the second distributing position 94.

On the other hand, when the width of the recording sheet is out of the possible length to distribute, the pairs of conveyer rollers 113 and 114 are released to let the recording sheet pass through without distributing it. This system prevents change in transportation speed or occurrence of the skew because the recording sheet is nipped by the pairs of conveyer rollers 113 and 114 during the passage through the sheet distributing section 30.

After passing the sheet distributing section 30, the recording sheet is sent to the processor 16 slowing down its speed, for example from the first speed 100 mm/sec to the second speed 45.3 mm/sec by the feed out section 32. In this process, the speed is controlled to fit to the processing ability of the processor 16. The processor 16 makes a photo print by carrying out such processes as developing and fixing on the recording sheet with the image recorded thereon, and sends it to the gathering section 62 after drying it at the dry section 61.

When being distributed to plural lines, the recording sheets are returned to single line at the gathering section 62 and then sent to the sorter 63. The sorter 63 sorts plural recording sheets by every print job and outputs them to the outside of the printer processor 10.

In the above described embodiment, because the pairs of conveyer rollers 113 and 114 nip the recording sheet symmetrically to the center line of the sub scan direction, no difference will result in abrasion degree of the rollers 113 and 114. Their symmetrical positions to the center line also reduce occurrence of the skew. Moreover, because the total length L1 of the conveyer rollers 113 and 114 in their axial direction, i.e. in the main scan direction, is shorter than the minimum width L2 of the recording sheets, the conveyer rollers 113 and 114 do not nip the side edges of the recording sheets. So the conveyer rollers 113 and 114 are prevented from being shaved off by the side edges of the recording sheets, and also from being stained with paper particles chipped out of the side edges of the recording sheet. The paper particles put on the conveyer rollers 113 and 114 could stain the recording surface of the rearward recording sheet, causing inadequate exposure.

While returning from the first or the second distributing position 92 or 94 to the center position 90, the pairs of conveyer rollers 113 and 114 are set in the releasing position. This permits carrying on return motion and acceptance of the next recording sheet at one time, as shown in FIG. 9, contributing to speeding up the processing.

Moreover, because the distributing motion is constant regardless of the width of the recording sheet thanks to the return motion to the center position 90 after every distributing motion, and is based on the result of the detection by the sensors 49 and 50, the distribution is simple and accurate.

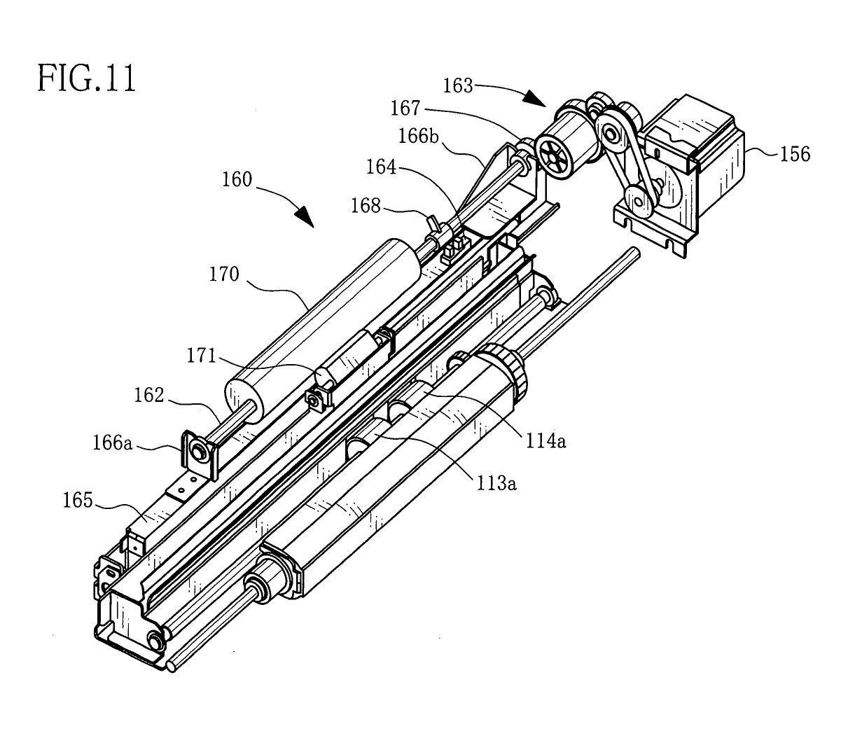

As for the releasing mechanism 160, instead of the way shown in FIG. 6, it is possible to use any way including for example other ones shown in FIGS. 11, 12 and 13 insofar as the way can switch the nip rollers 113b, 114b, 113c and 114c between the nip position and the release position.

In FIG. 11, instead of the press member 161, an eccentric cam 170, which is elongated in the main scan direction and almost cylindrical, is mounted on a bearing shaft 162. When the eccentric cam 170 supports a holding frame 171 on the shorter radial side like as shown in FIG. 11, nip rollers 113b, 114b, 113c and 114c held in the holding frame 171 are in the nipping position, though they are not shown in FIG. 11. When the rotating eccentric cam 170 supports the holding frame 140 on the longer radial side, the holding frame 140 rotates to the arrowed direction D1 in FIG. 5 and the nip rollers 113b, 114b, 113c and 114c are in the releasing position.

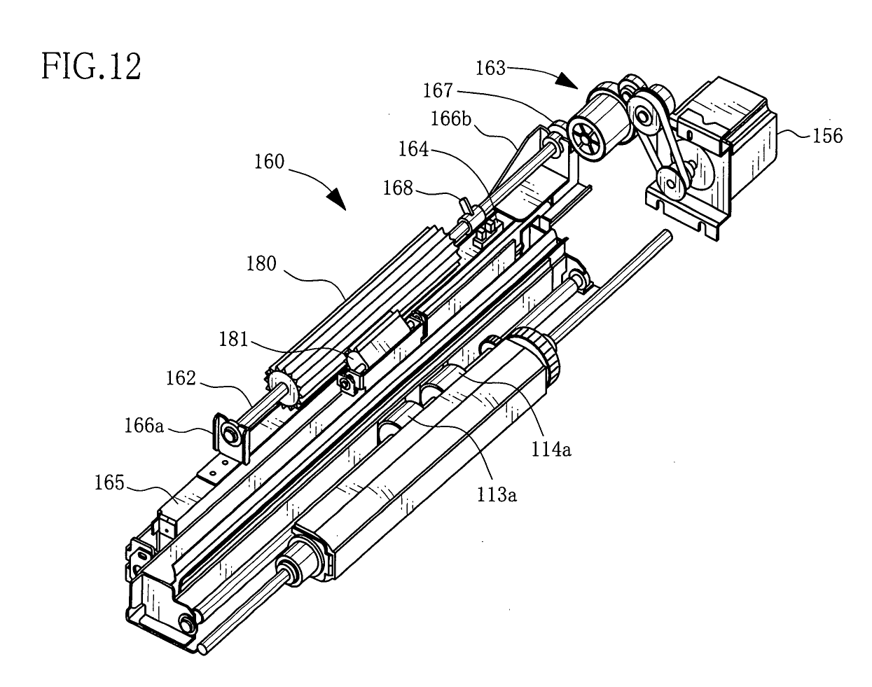

FIG. 12 shows another embodiment which provides a gear 180 elongated in the main scan direction around a bearing shaft 162 and makes the gear engage with another gear formed on a holding frame 181 holding nip rollers 113b, 114b, 113c and 114c, though they are not shown in FIG. 12. The rotation of the bearing shaft 162 causes to rotate the holding frame 181 connected through these gears to the bearing shaft 162, thereby switching the nip rollers 113b, 114b, 113c and 114c between the nipping position and the releasing position.

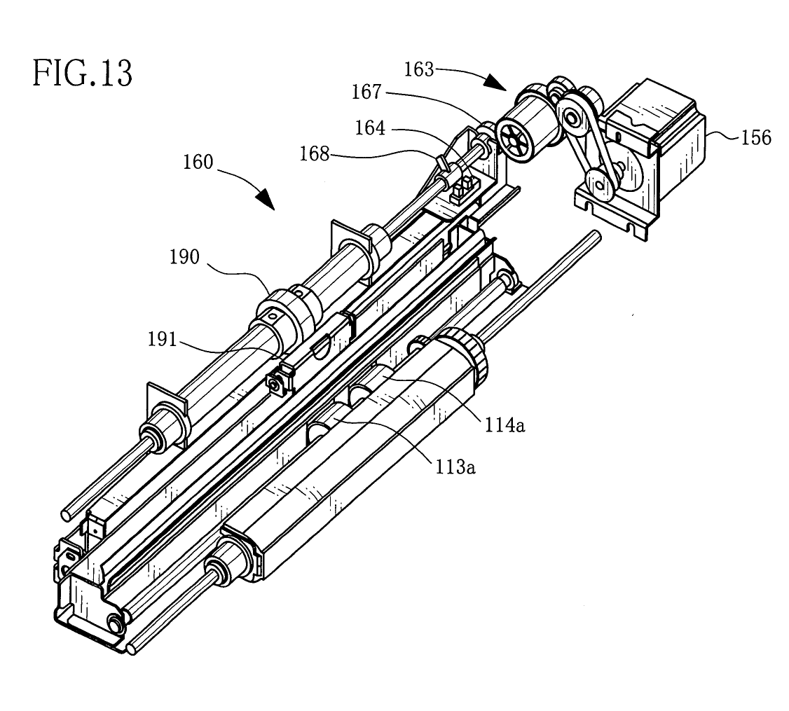

FIG. 13 shows still another embodiment using a pipe slide 190. The pipe slide 190 has the same internal mechanism as the pipe slide 130 used for distribution, and is mounted to a housing 111 of a movable body 110 so as to move in the main scan direction to release nip rollers. In addition to these, it is possible to attach a motor directly to a holding frame 191 and switch it by driving the motor, though it is not shown the drawings.

In the above described embodiment, the movable distributing mechanism 100 has two pairs of conveyer rollers 113 and 114. However it is possible to provide just one or more than two pairs of conveyer rollers insofar as the rollers nip a recording sheet symmetrically to the center line of the sub scan direction of the paper.

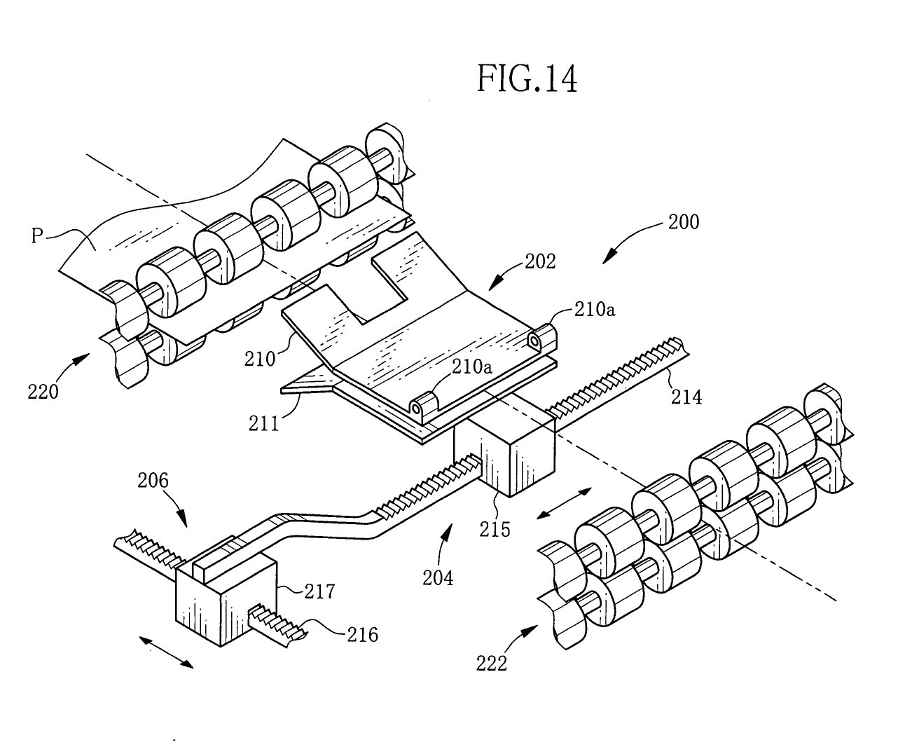

Although the above described embodiment uses the movable body 110 with two pairs of conveyer rollers 113 and 114 as the distributing device, the present invention is not to be limited to the distributing device of the above embodiment. For example, the distributing device may be a chuck mechanism 200 as shown in FIG. 14. The chuck mechanism 200 is constituted of a chucking member 202 for nipping the recording sheet P, a first movable member 204 for moving the chucking member 202 in the main scan direction and a second movable member 206 for moving the first movable member 204 together with the chucking member 202 in the sub scan direction.

The chucking member 202 is provided with an upper plate 210 and a lower plate 211. The lower plate 211 is affixed to the first movable member 204, whereas the upper plate 210 can flap about hinges 210a between a nipping position to nip the recording sheet P and a released position where the recording sheet P is released. The upper plate 210 is held by a not-shown frame or the like. For switching the upper plate 210, any conventional mechanism, such as a spring-and-cam mechanism or a spring-and-electromagnet mechanism, is usable.

The first movable member 204 is provided with a first arm 214 extending in the main scan direction, and a first movable body 215 mounted on the first arm 214. The first arm 214 is formed with a rack gear, whereas the first movable body 215 contains a not-shown pinion gear that is in mesh with the rack gear, and a not-shown motor for rotating the pinion gear. The first movable body 215 is mounted on the first arm 214 by the engagement between the pinion gear and the rack gear, and a not-shown slide bearing or the like. Driving the motor to rotate the pinion gear makes the lower plate 211 move together with the first movable member 204 in the main scan direction. The upper plate 210 moves along with the lower plate 211 through a not-shown transmission mechanism or the like.

The second movable member 206 is provided with a second arm 216 extending in the sub scan direction, and a second movable body 217 mounted on the second arm 216. The second movable member 206 fundamentally has the same structure as the first movable member 204, so the detailed description will be skipped. The second movable body 217 is securely connected to the first arm 214 of the first movable member 204, so the movement of the second movable body 217 along the second arm 216 causes the chucking member 202 to move in the sub scan direction together with the first movable member 204. Although the first and second movable members 204 and 206 are rack-and-pinion mechanisms in the illustrated embodiment, the chucking member 202 may be driven, for example, by a belt mechanism or an actuator.

The chuck mechanism 200 receives a recording sheet P from an upstream conveyer roller pairs 220, and distributes the recording sheet P in the main scan direction by driving the first movable member 204. At the same time, the chuck mechanism 200 carries the recording sheet P in the sub scan direction by driving the second movable member 206, to pass the recording sheet P to downstream conveyer roller pairs 222. Thus, the chuck mechanism 200 works in the same way as the above described movable body 110.

In the above described embodiment, the used printer processor is the type that makes a photo print by carrying out image recording based on digital data. However instead of such type of the printer processor, the present invention is applicable to another type printer processor, such as one that records an image by use of an optical image projected directly from photographic film.

1. A conveyer for conveying sheets sequentially in a transport direction, said conveyer comprising:
a distributing device movable in a distributing direction that is substantially orthogonal to the transport direction, while nipping and conveying the sheets one by one in the transport direction;
a shift device that drives said distributing device to move in the distributing direction;
a switching device for switching over said distributing device between a nipping position to nip the sheet and a releasing position to release the sheet;
a conveying device disposed behind said distributing device with respect to the transport direction, to nip and convey the sheet;
a first detector disposed between said distributing device and said conveying device, to detect the sheet passing through said first detector;
a second detector disposed behind said conveying device with respect to the transport direction, to detect the sheet passing through said second detector; and
a conveyance control device for controlling said distributing device through said shift device and said switching device such that said distributing device is switched to said nipping position at a reference position, to nip and convey a forward one of the sheets, and is moved in the distributing direction in response to that said first detector detects a leading end of said forward sheet, and that said distributing device is switched to said releasing position and moved back to said reference position, getting ready for nipping and conveying a rearward one of the sheets, in response to that said second detector detects the leading end of said forward sheet.

2. A conveyer as claimed in claim 1, wherein said conveyance control device controls said distributing device to switch from said releasing position to said nipping position in response to that said first detector detects a trailing end of said forward sheet.

3. A conveyer as claimed in claim 1, wherein said distributing device is movable in the distributing direction between a first position and a second position, which are substantially symmetrical about said reference position, and said distributing device moves to said first position to convey said forward sheet toward said conveying device and, thereafter, nips said rearward sheet at said reference position and moves to said second position to convey said rearward sheet toward said conveying device, to distribute the sheets as being conveyed in single line into two lines.

4. A conveyer device as claimed in claim 1, wherein said distributing device nips the sheet at symmetrical positions to a center line of the sheet with respect to the distributing direction.

5. A conveyer device as claimed in claim 4, wherein said distributing device comprises two pairs of rollers apposed along the distributing direction, axes of said rollers being parallel to the distributing direction.

6. A conveyer device as claimed in claim 5, wherein a total length of said two pairs of rollers in their axial direction is shorter than a length of the sheet in the distributing direction.

7. An image recording apparatus comprising:
an image recording section for recording an image on a recording material, said recording material being conveyed in a transport direction;
a photographic processing section for developing said recording material after having the image recorded thereon; and
a conveyer disposed between said image recording section and said photographic processing section, said conveyer being supplied with said recording materials in single line and feeding out said recording materials in plural lines, said conveyer comprising:
a distributing device movable in a distributing direction that is substantially orthogonal to the transport direction, while nipping and conveying said recording materials one by one in the transport direction;
a shift device that drives said distributing device to move in the distributing direction;
a switching device for switching over said distributing device between a nipping position to nip said recording material and a releasing position to release said recording material;
a conveying device disposed behind said distributing device with respect to the transport direction, to nip and convey said recording material;
a first detector disposed between said distributing device and said conveying device, to detect said recording material passing through said first detector;
a second detector disposed behind said conveying device with respect to the transport direction, to detect said recording material passing through said second detector; and
a conveyance control device for controlling said distributing device through said shift device and said switching device, such that said distributing device is switched to said nipping position at a reference position, to nip and convey a forward one of said recording materials, and is moved in the distributing direction in response to that said first detector detects a leading end of said forward recording material, and that said distributing device is switched to said releasing position and moved back to said reference position, getting ready for nipping and conveying a rearward one of said recording materials, in response to that said second detector detects the leading end of said forward recording material.

8. An image recording apparatus as claimed in claim 7, wherein said conveyance control device controls said distributing device to switch from said releasing position to said nipping position in response to that said first detector detects a trailing end of said forward recording material.

9. An image recording apparatus as claimed in claim 7, wherein said distributing device is movable in the distributing direction between a first position and a second position, which are substantially symmetrical about said reference position, and said distributing device moves to said first position to convey said forward recording material toward said conveying device and, thereafter, nips said rearward recording material at said reference position and moves to said second position to convey said rearward recording material toward said conveying device, to distribute said recording materials into two lines.

10. An image recording apparatus as claimed in claim 7, wherein said distributing device nips said recording material at symmetrical positions to a center line of said recording material with respect to the distributing direction.

11. An image recording apparatus as claimed in claim 10, wherein said distributing device comprises two pairs of rollers apposed along the distributing direction, axes of said rollers being parallel to the distributing direction.

12. An image recording apparatus as claimed in claim 11, wherein a total length of said two pairs of rollers in their axial direction is shorter than a length of said recording material in the distributing direction.

13. An image recording apparatus as claimed in claim 7, wherein said conveyer is assembled as a convertible unit.
